(19) United States
(12) Patent Application Publication
(10) Pub. No.: US 2006/0027316 A1
(43) Pub. Date: Feb. 9, 2006

(54) Laminating adhesive

(76) Inventors: Martin Jung, Manheim (DE); Wolfgang Paulus, Ober-Olm (DE); Hans-Joachim Fricke, Dirmstein (DE); Alexander Centner, Neustadt (DE)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/537,818

(22) PCT Filed: Dec. 16, 2003
(86) PCT No.: PCT/EP03/14273

§ 371 Date: Jun. 6, 2005

(30) Foreign Application Priority Data
Dec. 20, 2002 (DE) 102 61 196.3

(51) Int. Cl. B32B 37/00

(52) U.S. Cl. 156/272.2; 156/327

(57) ABSTRACT

A laminating adhesive comprising as binder a mixture of A) a polymer obtainable by polymerizing free-radically polymerizable compounds, and B) compounds containing ethylenically unsaturated, free-radically polymerizable groups (polymerizable groups for short) and having a weight-average molecular weight Mw of less than 5000 g/mol.

The invention relates to a laminating adhesive comprising as binder a mixture of
A) a polymer obtainable by polymerizing free-radically polymerizable compounds, and
B) compounds containing ethylenically unsaturated, free-radically polymerizable groups (polymerizable groups for short) and having a weight-average molecular weight Mw of less than 5000 g/mol.

The invention relates in particular to the use of the laminating adhesive in the lamination of composite films and high gloss films.

Laminating adhesives used include solvent-free polyurethane systems.

Known inter alia from DE 19935624 is the use of UV-crosslinkable aqueous polymer dispersions.

With aqueous polymer dispersions drying is required in order to remove the water.

There is therefore a desire for solvent-free laminating adhesives which are a possible alternative to the polyurethane systems.

Requirements of an alternative laminating adhesive include in particular the following:
high strengths of the assembly produced
good processing properties
low inputs, low applied weight
capacity for the assembly produced to be further processed rapidly
storage stability of the laminating adhesive
in the case of high gloss film lamination, no detachment of the film in the area of grooves and embossments.

It is an object of the present invention to provide laminating adhesives which as far as possible meet these requirements.

We have found that this object is achieved by the laminating adhesives defined at the outset and by their use in composite film and high gloss film lamination.

The laminating adhesive of the invention comprises as essential constituents polymers A) and compounds B).

As to the polymers A):

The polymer A) is preferably composed of free-radically polymerizable compounds (monomers).

The polymer is composed preferably of at least 40% by weight, more preferably of at least 60% by weight, and very preferably of at least 80% by weight of what are termed principal monomers.

The principal monomers are selected from C₁-C₂₀ alkyl (meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having 2 to 8 carbon atoms and 1 or 2 double bonds, and mixtures of these monomers.

Examples include (meth)acrylic acid alkyl esters with a C₁-C₁₀ alkyl radical, such as methyl methacrylate, methyl acrylate, n-butyl acrylate, ethyl acrylate and 2-ethylhexyl acrylate.

Mixtures of the (meth)acrylic acid alkyl esters as well are particularly suitable.

Vinyl esters of carboxylic acids having 1 to 20 carbon atoms include for example vinyl laurate, vinyl stearate, vinyl propionate, Versatic acid vinyl esters, and vinyl acetate.

Suitable vinylaromatic compounds include vinyltoluene, a- and p-methylstyrene, a-butylstyrene, 4-n-butylstyrene, 4-n-decylstyrene, and—preferably—styrene. Examples of nitriles are acrylonitrile and methacrylonitrile.

The vinyl halides are chlorine, fluorine or bromine substituted ethylenically unsaturated compounds, preferably vinyl chloride and vinylidene chloride.

Examples of vinyl ethers that may be mentioned include vinyl methyl ether and vinyl isobutyl ether. Vinyl ethers of alcohols comprising 1 to 4 carbon atoms are preferred.

Among hydrocarbons having 2 to 8 carbon atoms and one or two olefinic double bonds mention may be made of butadiene, isoprene and chloroprene, ethylene and propylene.

Preferred principal monomers are the C₁ to C₁₀ alkyl acrylates and methacrylates, especially C₁ to C₈ alkyl acrylates and methacrylates, particular preference being given in each case to the acrylates.

Especially preferred monomers are methyl acrylate, ethyl acrylate, n-butyl acrylate, n-hexyl acrylate, octyl acrylate, and 2-ethylhexyl acrylate, and mixtures thereof.

Besides the principal monomers the polymer may comprise further monomers, examples being monomers having carboxylic acid, sulfonic acid or phosphonic acid groups. Carboxylic acid groups are preferred. Examples that may be mentioned include acrylic acid, methacrylic acid, itaconic acid, maleic acid, and fumaric acid.

Further monomers include for example hydroxyl-comprising monomers as well, especially C₁-C₁₀ hydroxyalkyl (meth)acrylates, (meth)acrylamide, and monomers comprising ureido groups, such as ureido (meth)acrylates.

Additional further monomers that may be mentioned include phenyloxyethylglycol mono(meth)acrylate, glycidyl acrylate, glycidyl methacrylate and amino (meth)acrylates such as 2-aminoethyl (meth)acrylate.

Monomers which in addition to the double bond also carry other functional groups, such as isocyanate, amino, hydroxyl, amide or glycidyl, may have the effect, for example, of improving the adhesion to substrates. Those of particular suitability include cyclic lactams such as N-vinylpyrrolidone or N-vinylcaprolactam.

The polymer is preferably composed of at least 40% by weight, more preferably of at least 60% by weight, and very preferably of at least 80% by weight of C₁-C₂₀ alkyl (meth)acrylates, particularly the aforementioned alkyl (meth)acrylates.

The polymer is preferably one which can be crosslinked by irradiation with high energy light, e.g., UV light or electron beams.

The polymer is crosslinkable thus if, for example, it is possible to remove hydrogen protons from the main polymer chain photochemically, also in particular with the use of a photoinitiator or by means of electron beams, to form a free radical which is able to undergo further chemical reactions.

The laminating adhesive preferably comprises a photoinitiator.

The photoinitiator can be of the type known as α-splitters: that is, photoinitiators in which a chemical bond is cleaved to form 2 free radicals which initiate the subsequent crosslinking or polymerization reactions.

Examples that may be mentioned include acylphosphine oxides (Lucirin® products from BASF), hydroxyalkylphenones (e.g. Irgacure® 184), benzoin derivatives, benzil derivatives, and dialkyloxyacetophenones.

In particular they may be of the type known as H abstractors, which detach a hydrogen atom from the polymer chain; examples of such photoinitiators include those with a carbonyl group. This carbonyl group inserts itself into a C—H bond to form a C—C—O—H group.

Mention may be made here particularly of acetophenone, benzophenone, and derivatives thereof.

Both classes of photoinitiators can be used, alone or even in a mixture.

In one particular embodiment the photoinitiator or at least one of the photoinitiators, if a mixture is being used, is attached to the polymer A).

With particular preference it is a photoinitiator which is incorporated by free-radical copolymerization into the polymer chain. For that purpose the photoinitiator preferably includes an acryloyl or (meth)acryloyl group.

Suitable copolymerizable photoinitiators are acetophenone or benzophenone derivatives which comprise at least one, preferably one, ethylenically unsaturated group. The ethylenically unsaturated group is preferably an acryloyl or methacryloyl group.

The ethylenically unsaturated group can be attached directly to the phenyl ring of the acetophenone or benzophenone derivative. Generally there is a spacer group between phenyl ring and ethylenically unsaturated group.

The spacer group can comprise, for example, up to 100 carbon atoms.

Suitable acetophenone or benzophenone derivatives are described for example in EP-A-346 734, EP-A-377199 (1st claim), DE-A-4 037 079 (1st claim) and DE-A-3 844 444 (1 st claim), and by virtue of this reference to them are included in the disclosure content of the present specification. Preferred acetophenone and benzophenone derivatives are those of the formula 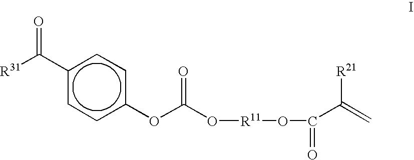
in which R¹¹ is an organic radical having up to 30 carbon atoms, R²¹ is a hydrogen atom or a methyl group, and R³ is a substituted or unsubstituted phenyl group or a C₁-C₄ alkyl group.

R¹¹ is with particular preference an alkylene group, especially a C₂-C₈ alkylene group.

R³¹ is with particular preference a methyl group or a phenyl group.

The laminating adhesive of the invention comprises preferably from 0.0001 to 1 mol, more preferably from 0.0002 to 0.1 mol, very preferably from 0.003 to 0.01 mol of the photoinitiator, or polymer-attached molecule group active as the photoinitiator, per 100 g of the total weight of A)+B).

The polymer A) preferably has a K value of from 10 to 90, in particular from 30 to 80, more preferably from 40 to 60, as measured in tetrahydrofuran (1% solution, 21° C.).

The K value of Fikentscher is a measure of the molecular weight and viscosity of the polymer.

The molar weight associated with the above K value range is far higher than the molar weight of the compounds B). The weight-average molar weight of the polymer A) is generally at least twice and in particular at least 10 times as high as that of the compounds B).

The glass transition temperature (Tg) of the polymer is preferably from −60 to +10° C., more preferably from −55 to 0° C., and very preferably from −55 to −10° C.

The glass transition temperature of the polymer can be determined by standard methods such as differential thermal analysis or differential scanning calorimetry (see for example ASTM 3418/82, midpoint temperature).

Polymers A) can be prepared by copolymerizing the monomeric components using the customary polymerization initiators and also regulators where appropriate, carrying out the polymerization at the customary temperatures without solvent, in emulsion, e.g., in water or liquid hydrocarbons, or in solution. The polymers are preferably prepared by polymerizing the monomers in solvents (solution polymerization), particularly in solvents with a boiling range of from 50 to 1500° C., preferably from 60 to 120° C., using the customary amounts of polymerization initiators, generally from 0.01 to 10% by weight, in particular from 0.1 to 4% by weight, based on the total weight of the monomers. Suitable solvents include in particular alcohols, such as methanol, ethanol, n-propanol and isopropanol, n-butanol and isobutanol, preferably isopropanol and/or isobutanol, and hydrocarbons such as toluene and, in particular, petroleum spirits with a boiling range of from 60 to 120° C. It is additionally possible to use ketones, such as acetone, methyl ethyl ketone, methyl isobutyl ketone, and esters, such as ethyl acetate, and also mixtures of solvents of the kind stated, preference being given to mixtures comprising isopropanol and/or isobutanol in amounts of from 5 to 95%, in particular from 10 to 80%, more preferably from 25 to 60% by weight based on the solvent mixture employed.

Suitable polymerization initiators in the case of solution polymerization include for example azo compounds, ketone peroxides, and alkyl peroxides.

After the polymerization in solution the solvents can where appropriate be separated off under reduced pressure, operating at elevated temperatures, in the range of from 100 to 150° C. for example. The polymers can then be used in the solvent-free state, i.e., as melts. In some cases it is also advantageous to prepare the polymers by bulk polymerization, i.e., without the use of a solvent, in which case it is possible to operate batchwise or else continuously, in accordance for example with the details in U.S. Pat. No. 4,042,768.

As to the compounds B):

Suitable compounds B) include customary free-radically polymerizable monomers of defined chemical structural formula and of an actual molar weight below 200 g/mol (referred to below as compounds B1).

Compounds B1 have a polymerizable group.

Compounds B1 include in particular the monomers listed above as possible components of the polymer A). Particular mention may be made of acrylic monomers containing an acryloyl or methacryloyl group.

Other compounds B, not included under B1, are referred to below as B2.

Compounds B2 are, in particular, (meth)acrylate compounds, preference being given in each case to the acrylate compounds, i.e., the derivatives of acrylic acid.

Preferred (meth)acrylate compounds B2 comprise 2 to 20, preferably 2 to 10, and very preferably 2 to 5 copolymerizable, ethylenically unsaturated double bonds.

The weight-average molecular weight M_{w} of the compounds B2 is preferably below 5000, more preferably below 3000 g/mol (as determined by gel permeation chromatography using polystyrene standards and tetrahydrofuran eluent). With especial preference it lies below 2000 and in particular below 1000 g/mol. With particular preference the M_{w} of B2 is greater than 250 and more preferably still greater than 400 g/mol.

As (meth)acrylate compounds mention may be made of (meth)acrylic esters and especially acrylic esters of polyfunctional alcohols, particularly those which other than the hydroxyl groups comprise no further functional groups or, if any at all, then just ether groups. Examples of such alcohols include difunctional alcohols, such as ethylene glycol and propylene glycol, and their more highly condensed counterparts, such as diethylene glycol, triethylene glycol, dipropylene glycol, and tripropylene glycol, etc., butanediol, pentanediol, hexanediol, neopentyl glycol, alkoxylated phenolic compounds, such as ethoxylated and/or propoxylated bisphenols, cyclohexanedimethanol, alcohols with a functionality of three or more, such as glycerol, trimethylolpropane, butanetriol, trimethylolethane, pentaerythritol, ditrimethylolpropane, dipentaerythritol, sorbitol, mannitol, and the corresponding alkoxylated alcohols, especially ethoxylated and propoxylated alcohols.

The alkoxylation products are obtainable conventionally by reacting the above alcohols with alkylene oxides, especially ethylene oxide or propylene oxide. The degree of alkoxylation per hydroxyl group is preferably from 0 to 10—in other words, 1 mol of hydroxyl group can be alkoxylated preferably with up to 10 mol of alkylene oxides.

Further (meth)acrylate compounds include polyester (meth)acrylates, which are the (meth)acrylic esters of polyesterols.

Examples of suitable polyesterols include those preparable by esterifying polycarboxylic acids, preferably dicarboxylic acids, with polyols, preferably diols. The starting materials for such hydroxyl-containing polyesters are known to the skilled worker. As dicarboxylic acids it is possible with preference to use succinic acid, glutaric acid, adipic acid, sebacic acid or o-phthalic acid, their isomers and hydrogenation products, and also esterifiable derivatives, such as anhydrides or dialkyl esters, of said acids. Polyols that may be considered include the abovementioned alcohols, preferably ethylene glycol, 1,2- and 1,3-propylene glycol, butane-1,4-diol, hexane-1,6-diol, neopentylglycol, cyclohexanedimethanol, and polyglycols of the ethylene glycol and propylene glycol type.

Polyester (meth)acrylates can be prepared in a plurality of stages or else a single stage, as described in EP 279 303 for example, from acrylic acid, polycarboxylic acid, and polyol.

Further possibilities for compounds B) include for example epoxy or urethane (meth)acrylates.

Epoxy (meth)acrylates are those, for example, obtainable by reacting epoxidized olefins or polyglycidyl, monoglycidyl or diglycidyl ethers, such as bisphenol A diglycidyl ether, with (meth)acrylic acid.

The reaction is known to the skilled worker and described for example in R. Holmann, U.V. and E.B. Curing Formulation for Printing Inks and Paints, London 1984.

Urethane (meth)acrylates are, in particular, reaction products of hydroxyalkyl (meth)acrylates with polyisocyanates and/or diisocyanates (again see R. Holmann, U.V. and E.B. Curing Formulation for Printing Inks and Paints, London 1984).

Particularly suitable compounds B are compounds B2 and mixtures of B2 and B1.

All in all compounds B) consist preferably of at least 50% by weight, more preferably of at least 75% by weight, of compounds B2). Preferred compounds B2 are the (meth)acrylic esters listed above.

For compounds B) in total, irrespective of whether they are B1, B2 or mixtures of B1 and B2, it holds that at 21° C. and 1 bar they are liquid.

The viscosity of the compounds B or of the mixture of the compounds B is preferably from 0.01 to 50 mPas, more preferably from 0.04 to 10 mPas, at 23° C. and 1 bar, measured in accordance with DIN EN ISO 3219; with very particular preference the viscosity is from 0.04 to 2 and in particular from 0.04 to 1 mPas.

Compounds B, or the mixture of compounds B, have or has on average from 1 to 5, preferably 1 to 3, more preferably from 1.5 to 2.5 polymerizable groups per molecule.

As to the mixture of A) and B)

The laminating adhesive comprises as binder a mixture of A) and B), the weight fraction of A) being preferably not more than 99% by weight, more preferably not more than 95% by weight, and being preferably at least 30% by weight, more preferably at least 50% or at least 60% by weight.

Correspondingly the weight fraction of B) is preferably not more than 70% by weight, more preferably not more than 50% by weight or not more than 40% by weight, and is preferably at least 1% by weight, more preferably at least 5% by weight.

Suitable weight ranges of A) and B) are in particular:
for A): 99 to 30% by weight, more preferably 95 to 50% by weight, very preferably 95 to 60% by weight, and in particular 95 to 70% by weight
for B): correspondingly 1 to 70% by weight, more preferably 5 to 50% by weight, very preferably 5 to 40% by weight, and in particular 5 to 30% by weight.

All weights indicated for A) and B) are based on the total weight of A) and B).

The mixture of A) and B) can be prepared by standard techniques.

Preferably polymer A) is heated, to temperatures for example of between 50 and 130° C., and compounds A) are stirred in, together where appropriate with additives.

As to the laminating adhesives:

The laminating adhesives can consist solely of the mixture of A) and B).

Water or other solvents, from the solution polymerization of A) for example, are preferably present in small amounts if at all.

The laminating adhesive preferably comprises less than 5 parts by weight, in particular less than 2 parts or 1 part by weight, of water and/or solvent per 100 parts by weight of the weight sum of A) and B). With particular preference the laminating adhesive is substantially free of water and other solvents.

The laminating adhesive preferably comprises at least one photoinitiator (see above). Where the photoinitiator in question is not attached to the polymer, the photoinitiator may be added to the mixture of A) and B) or even to the components A) or B) at any time.

Additives include for example stabilizers, biocides, and wetting agents.

The mixture of A) and B), together with additives where appropriate, is used as a laminating adhesive for bonding substrates of large surface area, in other words for producing laminates. The lower viscosity of the mixture relative to the polymer A) makes it easier to process.

Examples of suitable substrates to be bonded include polymer films, particularly those of polyethylene, oriented polypropylene, polyamide, polyester, e.g., polyethylene terephthalate (PET), cellulose acetate, regenerated cellulose film, metal (e.g., aluminum) coated (by vapor deposition) polymer film (for short: metallized films) or else paper, card or metal foils, particularly of aluminum. Said films and foils may also have been printed with printing inks, for example.

The laminating adhesive is applied to at least one large surface area substrate, preferably with a layer thickness of from 0.1 to 20 g/m², more preferably from 2 to 15 g/m², by knifecoating, spreading, etc., for example.

The coated substrate can be laminated immediately or at any later point in time to a second substrate, the laminating temperature being for example from 20 to 200° C., preferably from 20 to 70° C., and the laminating pressure being, for example, from 1 to 30, preferably from 3 to 20, N/m².

At least one of the two adherend substrates ought to be transparent to high energy light, particularly UV light or electron beams.

Where a photoinitiator is used said photoinitiator ought naturally to be activable in the wavelength range within which the film is transparent. In the case of PET films (transparency >320 nm), therefore, acylphosphine oxides are used.

The polymer or the dispersion is used preferably as an adhesive for high gloss film lamination or composite film lamination.

In the case of high gloss film lamination paper or card are bonded to transparent polymer films. The papers or cards may have been printed.

In the case of composite film lamination different films/foils are bonded to one another in order to combine their properties. Composite films are of importance, for example, in packaging.

Immediately after the adhesive bond has been formed the layer of laminating adhesive can be irradiated through the transparent film with high energy light, which triggers the crosslinking reactions.

The high energy light in question is preferably UV light or electron beams. For UV irradiation it is possible to use commercially customary medium pressure mercury lamps or lasers which emit in the UV range.

The radiant energy may amount, for example, to from 200 mJ to 1500 mJ per cm² of irradiated surface area.

Irradiation may be followed immediately by further processing, such as grooving or embossing of the laminated substrates, such as of cards laminated with film, for example. The adhesive layer is crosslinked right through and no longer tacky. With adhesive layers that are still tacky there is the problem in particular of contamination of tools, cutting tools for example, in the course of further processing.

A waiting time is now unnecessary.

The laminating adhesive of the invention produces substrate assemblies of high adhesive strength, which is present even in the area of grooves or embossments, and of high transparency and gloss.

The laminating adhesive is stable on storage. There is no need to dry the laminating adhesive after it has been applied to a large surface area substrate.

### EXAMPLES

Polymers A—Preparation

Abbreviations:

n-Butyl acrylate (BA)
Ethyl acrylate (EA)
Acrylic acid (AA)
Copolymerizable benzophenone derivative of the formula I (FI)

Isobutanol (BuOH)

| | Amount | | Ingredient |
|---|---|---|---|
| Initial charge 1 | Total: 179.1 g | | |
| | 125.918 | g | BuOH |
| | 50.464 | g | of feed 1 |
| | 2.718 | g | of feed 2 |
| Feed 1 | Total: 1009.28 g | | |
| | 895.0 | g | n-Butyl acrylate |
| | 70.0 | g | Ethyl acrylate |
| | 30.0 | g | Acrylic acid |
| | 14.286 | g | Photoinitiator in 35% form |
| Feed 2 | Total: 27.18 g | | |
| | 2.0 | g | tert-Butyl peroctoate |
| | 25.184 | g | BuOH |
| Feed 3 | Total: 18.78 g | | |
| 2 | 2.0 | g | tert-Butyl peroctoate |
| | 16.789 | g | of i-BuOH solvent |

BuOH Total: 167.89 g

Method:

Polymerization runs under a gentle stream of nitrogen. During the addition of feeds 1 and 2 the internal temperature is 100° C.

Start polymerization of initial charge at 100° C. for 10 minutes.

Feeds 1 and 2 are commenced simultaneously.

Feed Times:

Feed 1: 1 in 3 h
Feed 2: 2 in 3 h 15 min
Feed 3: 4 in 5 min

After the end of feed 2 meter in feed 3 in 5 min. Simultaneously with the beginning of feed 3 raise the temperature to 115° C. over the course of 15 min and polymerize to completion for a total of 45 min.

Until the end of the feeds the stirrer speed is 100 rpm and thereafter it is 75 rpm.

Following polymerization carry out degassing at 135° C. under reduced pressure for 1 h.

The composition of the polymers is indicated in Table 1.

TABLE 1

| | BA | EA | AA | FI | |
|---|---|---|---|---|---|
| | % by | % by | % by | % by | |
| Polymer | weight | weight | weight | weight | K value |
| A1 | 89.5 | 7 | 3 | 0.5 | 45.1 |
| A2 | 90 | 7 | 3 | — | 43.8 |

Preparation of the Laminating Adhesives

The compound used as compound B was an alkoxylated trimethylolpropane triacrylate having a viscosity of 0.07-0.13 mPas.

Where a separate photoinitiator was used it was dissolved at 70° C. in compound B.

Photoinitiators Used:

Irgacure 184: Phenyl 1-hydroxycyclohexyl ketone
Benzophenone

Polymer A was heated at 100° C. and the compound B, heated to 70° C., or the above solution, was stirred in.

The viscosity of polymer A) is 70 000 mPas, that of the mixtures 13 000 mPas.

High Gloss Film Lamination

Substrates:

Chromoduplex 2 card, printed
Chromolux 700 card, printed
Polypropylene, electrically pretreated on one side (PP) or polyester terephthalate film (PET)

The adhesive under test (whose temperature is 95° C.) is coated directly onto the PP or PET film using a bar coater (adhesive application rate 5-6 g dry/m²). The printed card was pressed on in a roller laminating station at 70° C.

The assembly was then irradiated with UV light through the transparent film. The irradiation dose was 62 mJ/cm².

The resultant adhesive layers are tack-free.

Embossing is the mechnical deformation of the surface of the laminated substrates by means of a pattern roller on the film side.

The laminate, following UV irradiation, was embossed in a roll mill with an embossing roller on the film side. After selected storage times the embossed assemblies are tested for detachment of the laminating film from the card, and assessed (see ratings under Table 4).

Fluting is the mechanical deformation (grooves) of high gloss film laminates.

Following UV irradiation, the laminate was fluted in a lever press. After selected storage times the grooves are tested for detachment of the laminating film from the card, and assessed (see ratings under Table 3).

The adhesion is tested by removing the film from the card at an angle of approximately 180 degrees, and assessed (see ratings under Table 2).

TABLE 2
Assessment of adhesion

| | Application weight 6 g/m2, | | |
|---|---|---|---|
| Adhesive | PP film 12 μm, Chromolux 700 | | |
| (parts by weight) | immediately | after 1 day | after 1 week |
| 2 A1 | 4 | 2-3 | 2 |
| 1 B | | | |
| 5% Irgacure 184 | | | |
| 2 A1 | 1 | 1 | 1 |
| 1 B | | | |
| 5% | | | |
| Benzophenone | | | |
| 2 A2 | 4 | 2 | 2 |
| 1 B | | | |
| 5% Irgacure 184 | | | |
| 2 A2 | 1 | 1 | 1 |
| 1 B | | | |
| 5% | | | |
| Benzophenone | | | |

Rating:
1 = Complete tearout of paper or fiber
2 = Partial tearout of paper or fiber
3 = Good adhesion with adhesive fracture of card or film
4 = Poor adhesion
5 = No adhesion to card or film

The amount by weight of the photoinitiator is indicated in % by weight, based on the sum A+B.

TABLE 3
Fluting

| | Application weight 6 g/m2, | | |
|---|---|---|---|
| Adhesive | PP film 12 μm, Chromolux 700 | | |
| (parts by weight) | immediately | after 1 day | after 1 week |
| 2 A1 | 1 | 1 | 1 |
| 1 B | | | |
| 5% Irgacure 184 | | | |
| 2 A1 | 1 | 1 | 1 |
| 1 B | | | |
| 5% | | | |
| Benzophenone | | | |
| 2 A2 | 1 | 1 | 1 |
| 1 B | | | |
| 5% Irgacure 184 | | | |
| 2 A2 | 1 | 1 | 1 |
| 1 B | | | |
| 5% | | | |
| Benzophenone | | | |

Rating:
1 Groove is entirely satisfactory
2 Groove has opened slightly at isolated points
3 Groove has opened significantly at isolated points
4 Groove is completely open

TABLE 4
Embossing

| | Application weight 6 g/m2, | | |
|---|---|---|---|
| Adhesive | PP film 12 μm, Chromolux 700 | | |
| (parts by weight) | immediately | after 1 day | after 1 week |
| 2 A1 | 1 | 1 | 1 |
| 1 B | | | |
| 5% Irgacure 184 | | | |
| 2 A1 | 1 | 1 | 1 |
| 1 B | | | |
| 5% | | | |
| Benzophenone | | | |
| 2 A2 | 1 | 1 | 1 |
| 1 B | | | |
| 5% Irgacure 184 | | | |
| 2 A2 | 1 | 1 | 1 |
| 1 B | | | |
| 5% | | | |
| Benzophenone | | | |

Rating:
1 = Impressions opened: 0 to <10%
2 = Impressions opened: >=10 to <=40%
3 = Impressions opened: >=40 to <=60%
4 = Impressions opened: >60 to <=90%
5 = Impressions opened: >90 to 100%

1. A method of making a laminate comprising
applying, to at least one substrate, a laminating adhesive comprising
A) a polymer comprising free-radically polymerized compounds, and
B) compounds comprising ethylenically unsaturated, free-radically polymerizable groups wherein the compounds have a weight-average molecular weight Mw of less than 5000 g/mol, and
bonding the at least one substrate to a transparent film to form a laminate of the at least one substrate and the transparent.

2. The method of claim 1, wherein the polymer is composed of at least 40% by weight of (meth)acrylates.

3. The method of claim 1, wherein the polymer is crosslinkable by irradiation with high-energy light.

4. The method of claim 1, wherein attached to the polymer is a photoinitiator.

5. The method of claim 1, wherein the polymer has an average molar weight which is at least twice as high as the molar weight of B).

6. The method of claim 1, wherein the polymer has a K value of from 10 to 90 as measured in a 1% tetrahydrofuran solution at 21° C.

7. The method of claim 1, wherein the polymer is a solution polymer.

8. The method of claim 1, wherein the compounds B) at 21° C. and 1 bar are liquid and have a viscosity of from 0.05 to 50 Pas.

9. The method of claim 1, wherein the compounds B) comprise from 1 to 5 polymerizable groups per molecule.

10. The method of claim 1, wherein the polymerizable groups of the compounds B) are acryloyl or methacryloyl groups.

11. The method of claim 1, wherein the compounds B) are (meth)acrylic esters of polyhydric, unalkoxylated or alkoxylated alcohols.

12. The method of claim 1, wherein the weight fraction of the compounds B) is from 5 to 70% by weight, based on the total weight of A)+B).

13. The method of claim 1, further comprising from 0.0001 to 1 mol of a photoinitiator or photoinitiator group per 100 g of the total weight of polymer A) and compounds B).

14. The method of claim 1, further comprising less than 5 parts by weight of water or solvent, based on 100 parts by weight of the total weight of A) and B).

15. (canceled)

16. The method of claim 1, wherein the transparent film carries print.

17. A laminate produced by the method of claim 1.

18. The method of claim 1, wherein the transparent film is transparent to UV light.

19. The method of claim 1, wherein the transparent film is transparent to an electron beam.

20. The method of claim 1, further comprising irradiating the transparent film with high-energy light.
